(19) United States
(12) Patent Application Publication
(10) Pub. No.: US 2026/0366570 A1
(43) Pub. Date: Nov. 19, 2026

(54) SPLIT ROLLING ELEMENT BEARING CAGE

(71) Applicant: COOPER ROLLER BEARINGS COMPANY LTD., Norfolk (GB)

(72) Inventor: Martin CASPALL, Norfolk (GB)

(21) Appl. No.: 19/483,557

(22) PCT Filed: May 9, 2024
(86) PCT No.: PCT/GB2024/051211

§ 371 Date: Nov. 11, 2025

(30) Foreign Application Priority Data
May 11, 2023 (GB) 2307004.8

(51) Int. Cl. F16C 33/51; F16C 19/38; F16C 33/48; F16C 33/50

(52) U.S. Cl. CPC F16C 33/516; F16C 19/38; F16C 33/48; F16C 33/504; F16C 2226/74

(57) ABSTRACT

The invention provides a cage for a split rolling element bearing comprising a first cage portion (100), a second cage portion (200) separable from the first cage portion, and a spring fitting (300) configured to releasably connect the first and second portions together to form the cage in use. With one end of the spring fitting initially inserted in a radial direction into the main aperture of the first cage portion, the action of bringing the two cage halves together automatically inserts the other end of the spring fitting into the main aperture of the second cage portion in a circumferential/tangential direction by means of a snap-fit engagement. The dimensions of the spring fitting and the spring properties are configured to provide an engagement force in a circumferential/tangential direction (i.e. normal to the mating surfaces) to pull and retain the two cage portions together. The spring halves are held together in compression in the axial direction, which provides the engagement force in the circumferential/tangential direction due to the configuration of the contact faces.

### TECHNICAL FIELD

The present invention relates to a split rolling element bearing cage and to a split roller bearing including the cage.

### BACKGROUND

In a split rolling element bearing, the cage is the component which separates and guides the rolling elements. It is arranged in two halves, which in most instances are required to be held together. FIG. 1 shows a prior art split spherical roller bearing cage, formed of two cage halves 1, 2 and a plurality of rollers 3. The space between the two rows of rollers is employed for screws 4 to hold the two halves of the cage together.

In some applications, for example in smaller sizes of bearing of the same general configuration as FIG. 1, there may not be enough space for suitably sized screws in the same location.

In some applications, such as in split cylindrical roller bearings, it may be possible to employ “U” clips for which recesses are created in the roller pockets nearest to the joints. However, in split spherical roller bearings, the roller pockets are of complex form and in smaller sizes of split spherical roller bearings, it may not be possible to create recesses for the U clips without removing functional features of the roller pockets.

Therefore, there is a need for a method of joining the two halves of the cage which can be employed in smaller sizes of bearing and which does not interfere with the roller pockets.

Since the cage is subject to not only the centrifugal action of the cage itself, but also to dynamic loads, including impacts, from the rollers, it is desirable for the means of joining the two halves together to not only to hold the two halves of the cage together when a minimum static load is applied, but also to avoid failure from wear or fatigue from these dynamic loads when in service. This precludes the use of certain snap fittings which may provide adequate static loading capacity, but which are subject to wear and/or fatigue when subject to dynamic loading. One of the reasons why such fittings may fail is that they do not hold the two components tightly together; the two halves of the cage may be held in the correct relative positions when the minimum static load is applied, but there is little or no interface force between the two halves of the cage, so the fitting is subjected to the dynamic loads applied to the cage.

The present invention, at least in its preferred form, seeks to address some or all of the above issues.

### SUMMARY OF THE INVENTION

In accordance with one aspect, the invention provides a cage for a split rolling element bearing comprising: a first cage portion; a second cage portion separable from the first cage portion; and a spring fitting configured to releasably connect the first and second portions together to form the cage in use, wherein each cage portion has a mating surface which is configured to contact the other cage portion when the first and second cage portions are engaged in use and a recess extending circumferentially/tangentially from the mating surface, wherein each recess has a main aperture and a neck region located circumferentially/tangentially between the main aperture and the mating surface, wherein the main aperture is wider in the axial direction than the neck region, wherein the spring fitting comprises first and second end sections joined by a centre section, wherein the first and second end sections are wider in the axial direction than the centre section such that, when the mating surfaces of each cage portion are in contact, each spring fitting end section is configured to be located in a respective main aperture and the centre section extends across the neck regions, and the spring fitting is configured to provide an engagement force in the circumferential/tangential direction which retains the first and second cage portions in the engaged position.

The two cage portions when assembled form a circular or substantially circular bearing cage. The cage portions may be made from a single ring of material, which is subsequently cut to form the two separate cage portions. Each cage portion may form half or substantially half of the whole cage when assembled.

Each mating surface is preferably planar, and is further preferably parallel to a radius of the cage.

Unless otherwise described, the circumferential direction is intended also to be the tangential direction at the relevant point.

The spring fitting is preferably formed from a spring material, such as spring steel. The spring fitting may be hollow. For example, the spring fitting may be formed from a strip of spring steel formed into shape, with a central aperture. The aperture may extend in a radial direction when located in the first and second cage portions in use. The first end section of the spring fitting is preferably continuous and the second end section of the spring fitting is preferably discontinuous or open, such that the two halves of the spring fitting at the second end section can be urged together, against the spring force provided by the spring fitting. The spring fitting may have a generally U-shaped section.

The first cage portion is also referred to as the lower cage half in the preferred embodiment described with reference to the figures below, and the second cage portion is the upper cage half. The terms “lower” and “upper” are simply to differentiate the two cage halves and do not imply a particular orientation of the cage halves. In addition, the term “half” does not necessarily imply that the component is exactly half of the bearing cage.

In at least preferred embodiments, the spring fitting first end section (which may be the closed or continuous end) is configured to fit into the main aperture of the first cage portion and the spring fitting second end section (which may be the open, split or discontinuous end) is configured to fit into the second cage portion.

In a preferred embodiment, the spring fitting first end section is configured to be inserted into the main aperture of the first cage portion in a radial direction and the spring fitting second end section is configured to be inserted into the main aperture of the second cage portion in a circumferential/tangential direction.

Preferably, with the spring fitting initially inserted in the main aperture of the first cage portion, the action of bringing the two cage halves together automatically urges the two halves of the spring fitting second end section together so that they pass the neck region of the second cage portion and expand outwards again into the main aperture of the second cage portion to secure the two cage halves together. This may be defined as a snap-fit engagement.

In order to assist with the engagement, the ends of the spring fitting at the second end may be angled towards each other. This provides lead-in sections which engage with the second cage portion (e.g. the guide surfaces described below) so that the two halves of the spring fitting at the second end section can be urged together. Additional features may be provided to assist insertion of the spring fitting, such as removal, rounding or smoothing of corners, or a combination.

The second cage portion recess may be provided with one or more guide surfaces between the mating surface and the neck region to guide the spring fitting into the main aperture during insertion. These surfaces help to guide the second end section of the spring fitting into the second cage portion recess. When the spring fitting is U-shaped or hollow, these surfaces gradually compress the open ends of the spring fitting as the cage portions are urged together, i.e. when second end section is being inserted circumferentially into the second cage portion. Preferably, two guide surfaces are provided, one each side of the recess (axially).

The one or more guide surfaces may be any suitable shape to perform the guiding function such as planar, curved or concave. The guide surface may have an angle of between 45° and 70° to the axial direction. Preferably the guide surface is an arc of a cylinder when viewed radially. The one or more guide surfaces may be formed by a drilling method as described in the preferred embodiment below.

The cage portion neck region is preferably formed by a projection on one or both sides of the recess. A main aperture contact face is preferably formed adjacent the projection, forming part of the edge of the main aperture of the recess. A corresponding contact face may be provided on the spring fitting. The spring fitting contact face may be located between the wider end section and the narrower centre section, and can provide a transition between the two sections.

The contact faces of the main aperture and the spring fitting are preferably configured to engage when the spring fitting is inserted into the recess. When the spring fitting is inserted into both recesses, the spring is held in compression in the axial direction which, through the engagement of the contact faces, provides the engagement force in the circumferential/tangential direction which urges and holds the cage portions together.

The dimensions of the spring fitting and the spring properties are configured to provide an engagement force in a circumferential/tangential direction (i.e. normal to the mating surfaces) to pull and retain the two cage portions together. The spring halves are held together in compression in the axial direction, which provides the engagement force in the circumferential/tangential direction due to the configuration of the contact faces.

The contact faces constitute the main contact points between the cage portions and the spring fitting. There is preferably minimal or no contact between the spring fitting centre section and the neck region when the spring is in position.

The preferred arrangement is to provide two main aperture contact faces on each side of each main aperture (of the first and second cage halves), and corresponding contact faces on the spring fitting between each wider end section (first and second end sections) and the narrower centre section, on each side of the spring. This provides four pairs of corresponding contact faces in total.

The contact faces may be planar or curved, convex, concave or circular. In the preferred arrangement, the contact faces are planar.

Preferably, the main aperture contact face is substantially planar and is at an angle of between 20 degrees and 70 degrees to the plane of the mating surface, when viewed from a radial direction, or to a plane through the axis of the bearing which intersects with the contact face (e.g. if the mating surface is not planar). The angle may be between about 20-70 degrees, 30-60 degrees, 40-50 degrees, or about 45 degrees. As explained above, the function of the contact faces is to provide a component of the axial spring tension force in the circumferential/tangential direction to pull the cage portions together. As shown in the drawings and described below, it will be understood that the main aperture contact faces face “away” from the mating surface.

When the main aperture contact face is substantially planar, the spring fitting contact face is also preferably substantially planar and is substantially parallel to the corresponding main aperture contact face with which the spring fitting contact face engages in use.

In a preferred embodiment, the main aperture is provided with a projection or flange (projecting into the main aperture) which is configured to prevent movement of the spring fitting in a radially-outward direction when the spring fitting is engaged with the first and/or second cage portion. The projection or flange may be located at the radially-outer end of the main aperture. The projection provides a positive location for the spring fitting during insertion and can prevent the spring fitting working its way outwards in service. The projection or flange may be provided on both cage halves, but this may complicate the spring fitting insertion procedure, so the projection or flange is provided on the second cage portion only in a preferred arrangement. Two projections/flanges may be provided, on opposite sides of the main aperture. The projection/flange may be in the form of the outer retainers as shown in the drawings and discussed below.

The main aperture may alternatively or additionally be provided with a projection or flange (projecting into the main aperture) to prevent movement of the spring fitting in a radially-inward direction when the spring fitting is engaged with the first and/or second cage portion. The projection or flange may be located at the radially-inner end of the main aperture. The projection prevents the spring fitting being pushed through the main aperture during insertion, provides a positive location for the spring fitting, and prevents the spring fitting working its way inwards during service. The projection or flange may be provided on the first cage portion only, or on both cage portions. The projection/flange may be in the form of the inner backstop as shown in the drawings and discussed below.

The present invention also provides a split rolling element bearing including the cage as discussed above. The bearing type may be selected from: a split roller bearing, a split spherical roller bearing, a split cylindrical roller bearing, and a split taper roller bearing.

### BRIEF DESCRIPTION OF THE DRAWINGS

Embodiments of the invention will now be described by way of example only and with reference to the accompanying drawings, in which:

FIG. 1 shows a prior art split spherical roller bearing cage and rollers;

FIGS. 2A and 2B show a perspective view and detail view respectively of a split roller bearing cage in accordance with the invention;

FIG. 3 shows a detail side elevation view (looking along a radius of the bearing) of the outside of the split roller bearing cage with the spring fitting not present and the two cage halves separated;

FIG. 4 shows a detail perspective view of the inside of the split roller bearing cage with the cage halves in the same position as FIG. 3;

FIG. 5 shows a similar view to FIG. 3, with the two cage halves together, to show the geometry of the apertures of each cage half;

FIG. 6 shows a perspective view of a spring fitting of the invention, in accordance with a first embodiment;

FIG. 7 shows a perspective view of a spring fitting of the invention, in accordance with a second embodiment;

FIG. 8 shows a detail side elevation view (looking along a radius of the bearing) of the outside of the split roller bearing cage with the spring fitting located in the lower cage half only and the two cage halves separated; and

FIG. 9 shows a detail side elevation view (looking along a radius of the bearing) of the outside of the split roller bearing cage with the spring fitting located in both cage halves and the cage halves secured in engagement by the spring fitting.

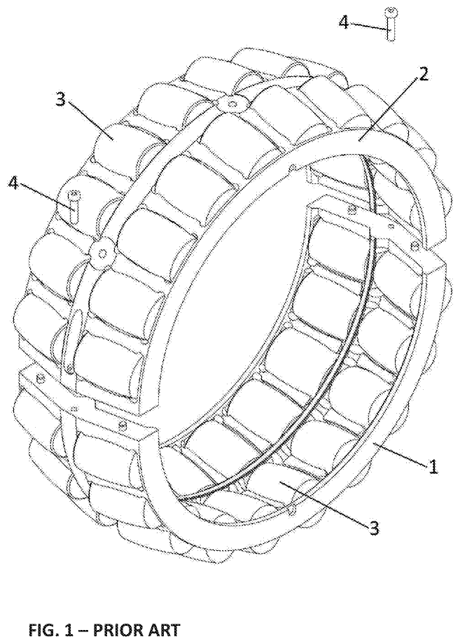

### DETAILED DESCRIPTION OF A PREFERRED EMBODIMENT

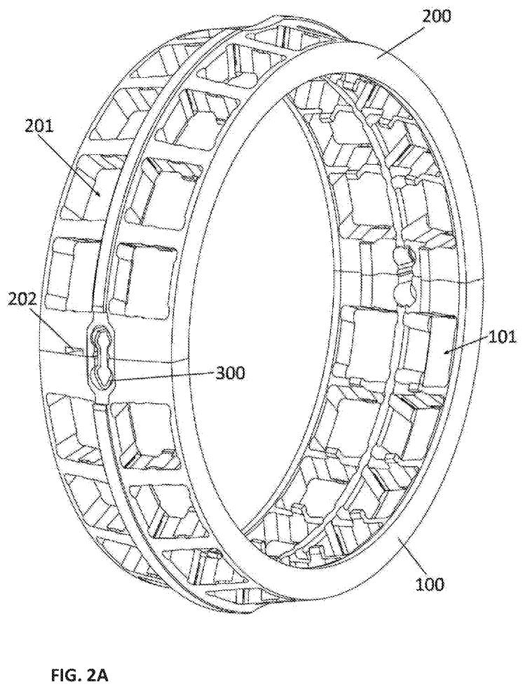

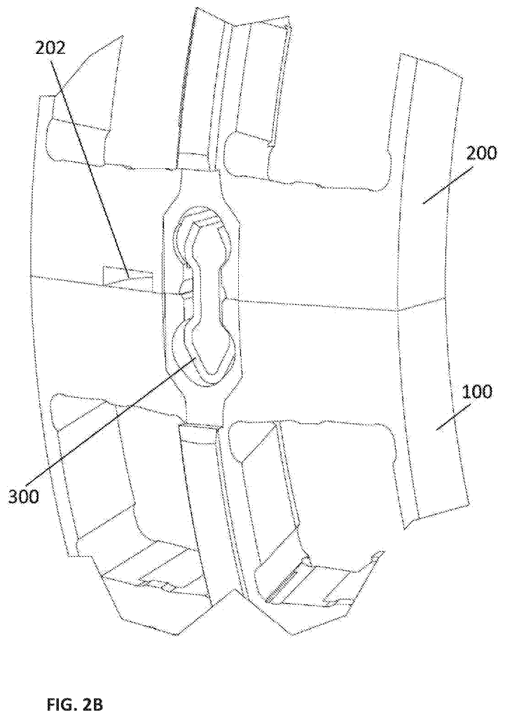

With reference to FIGS. 2A and 2B, a perspective view and a detail view respectively are shown of a split roller bearing cage in accordance with the invention. The main components of the invention are shown, comprising a lower cage half 100 (also referred to as the first cage portion), an upper cage half 200 (also referred to as the second cage portion) and a spring fitting 300. The terms “lower” and “upper” are merely used for convenient explanation of the cage as shown in the drawings, but the halves may be in any orientation. The term “halves” is also used for simplicity, but as discussed above, they may not be exact halves, but may extend through greater than or less than 180 degrees. In FIGS. 2A and 2B, the cage halves 100, 200 are shown engaged together by means of the spring fitting 300. Each cage half is provided with a plurality of roller pockets 101, 201 but the rollers themselves are omitted. A pry slot 202 is provided to enable the two halves to be separated if required using a suitable tool.

Although the invention will be described with reference to the features of the cage halves and spring fitting on one side of the bearing cage, it should be understood that similar features can be provided on the other side of the cage. It will be appreciated that the spring fittings and associated features of the cage halves may be in the same orientation on both sides or may be in opposite orientations. In some applications, the closed ends of the spring fittings (discussed below) are located in the same cage half. However, if it is desirable to keep the two halves in their original relative orientation after they have been formed (usually by machining), then the closed ends of the spring fittings could be located in opposite halves. Alternatively, additional means such as offset dowels could be employed if the closed ends are to be located in the same cage half and the relative orientation of the halves is to be maintained.

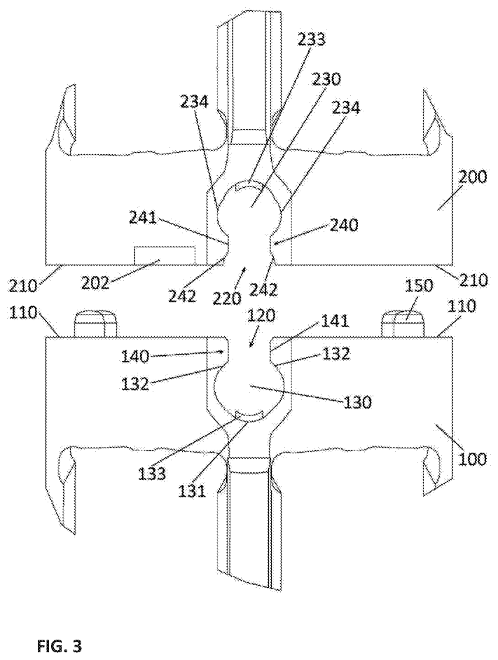

Referring to FIGS. 3, 4 and 5, the features of the cage halves will now be discussed. Lower cage half 100 has a mating surface 110 which is configured to contact upper cage half 200 when the cage halves are engaged in use. A recess 120 extends circumferentially from the mating surface and comprises a main aperture 130 and an axially-narrower neck region 140 located circumferentially between the main aperture 130 and the mating surface 110.

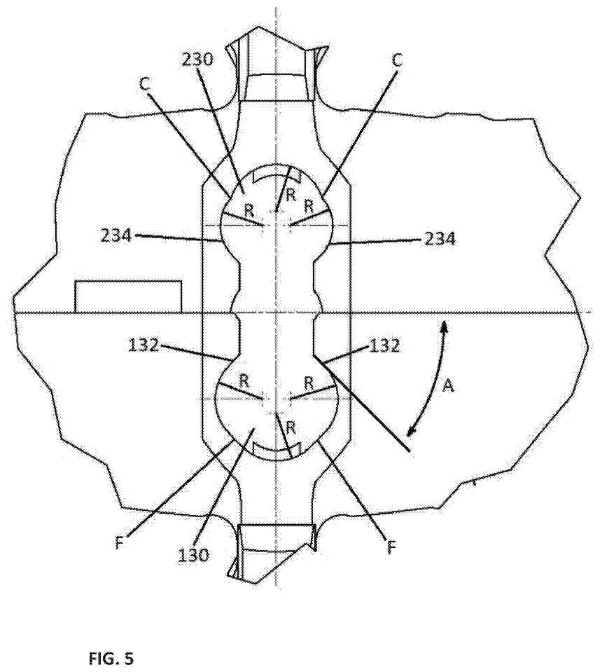

The main aperture 130 extends through the lower cage half 100 and may have any suitable cross-sectional profile, including generally cylindrical, when viewed along a radius of the bearing. However, the cross-sectional profile in this embodiment is discussed further below and specifically with reference to FIG. 5.

The lower surface 131 of the main aperture may contact the closed end of the spring fitting, as discussed further below. The main aperture also has contact faces 132 for engagement with corresponding contact faces on the spring fitting, as discussed further below. A backstop 133 is provided at the radially-inner end of the main aperture 130 to prevent movement of the spring fitting 300 in a radially-inward direction when the spring fitting is engaged with the lower cage half 100. The neck region 140 is formed by projections 141 on each side of the recess, near the entrance to the recess from the mating surface 110. Dowels 150 are provided which project from the mating surface 110 and engage with corresponding recesses in the upper cage half mating surface 220 (not shown).

Upper cage half 200 has a mating surface 210 which is configured to contact lower cage half 100 when the cage halves are engaged in use. A recess 220 extends circumferentially from the mating surface and comprises a main aperture 230 and an axially-narrower neck region 240 located circumferentially between the main aperture 230 and the mating surface 210.

The main aperture 230 extends through the upper cage half 200 and may have any suitable cross-sectional profile, including generally cylindrical, when viewed along a radius of the bearing. However, the cross-sectional profile in this embodiment is discussed further below and specifically with reference to FIG. 5.

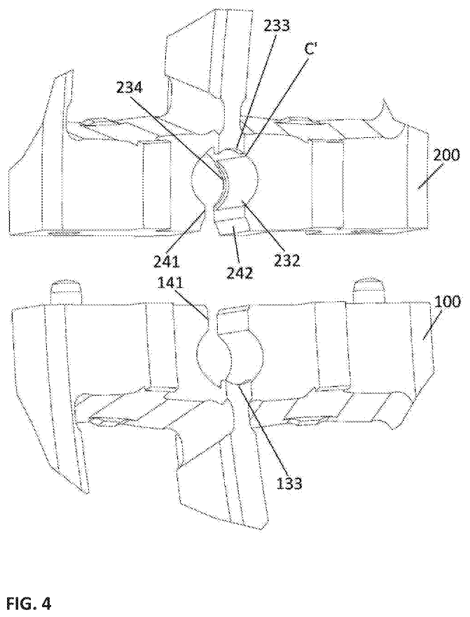

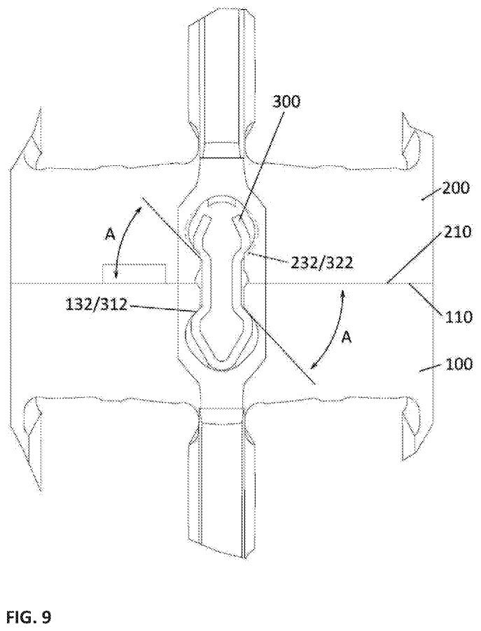

The main aperture has contact faces 232 (FIG. 4) for engagement with corresponding contact faces on the spring fitting, as discussed further below. A backstop 233 is provided at the radially-inner end of the main aperture 230. This can prevent movement of a suitably-sized spring fitting in a radially-inward direction when the spring fitting is engaged with the upper cage half 200, however in the present embodiment (with reference to FIG. 9), due to the size and configuration of the spring fitting 300, the backstop 233 does not have a function. Two retainers 234 are provided at the radially-outer end of the main aperture 230 to prevent movement of the spring fitting in a radially-outward direction when the spring fitting is engaged with the upper cage half 200. The neck region 240 is formed by projections 241 on each side of the recess, near the entrance to the recess from the mating surface 210.

Guide surfaces 242 are formed between the mating surface 210 and the neck region 240 to guide the spring fitting 300 into the main aperture 230 during insertion, as discussed further below. Guide surfaces 242 may be planar, such as an angled surface or chamfer, but in this embodiment the surfaces are circular in section when viewed along a radius of the bearing and are effectively cylindrical arcs.

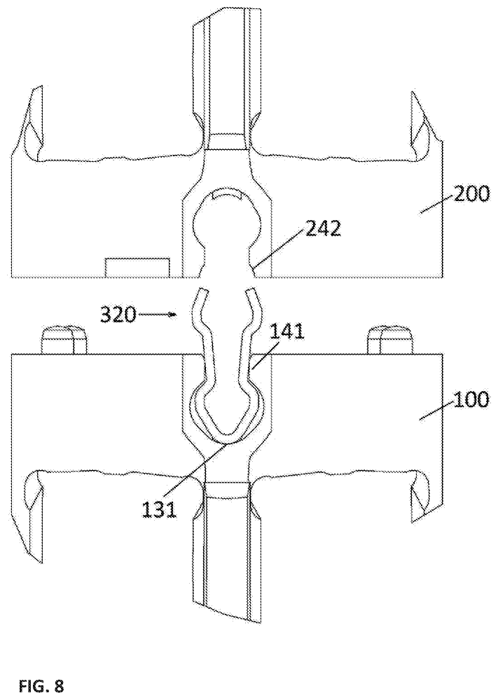

It would be possible to create these guide surfaces by milling them after the cages had been cut into two halves (the cage being manufactured from a complete ring of material). However, a preferred and more economical method of forming the guide surfaces is to drill a hole before the complete cage is cut into two halves, so the guide surfaces are actually arcs of the same cylinder. If a hole is drilled centrally to the position of the cage splitting cut, the hole forms equal surfaces on both the top and bottom halves of the cage, although cutting the cage in half removes an amount of material at the position of the cut. In the preferred method, the drilled hole is offset towards the upper cage half 200 to avoid excessive/unnecessary removal of cage material from the lower cage half 100, although a smaller amount of material may still be removed from the lower cage half as can be seen in FIGS. 3 and 4. If too much material is removed from the lower cage half, the spring fitting may not be held sufficiently closed in the configuration of FIG. 8 as discussed below and the upper ends of the spring fitting may not engage the guide surfaces 242.

FIG. 4 shows the lower cage half backstop 133, upper cage half backstop 233 and one of the upper cage half retainers 234. Contact face 232 is also shown.

FIG. 5 shows the geometry of the apertures of each cage half. Lower cage half aperture 130 is formed from three arcs each having a radius R, which may or may not be the same for each arc. The radii do not have coincident centres. The arcs are separated by flat sections F. Planar contact faces 132 extend from the ends of each side arc towards the neck region 140. The angle of the contact faces to the plane of the mating surface 110 is shown by the arrow A, as discussed further below.

The view of upper cage half aperture 230 in FIG. 5 includes the profiles of the outer retainers 234. The profile of the aperture including the outer retainers 234 is formed from three arcs each having a radius R, which may or may not be the same for each arc. The radii do not have coincident centres. The arcs are not separated by flat sections, so two corners C are formed at the junctions of the arcs.

The profile of the aperture behind the outer retainers (including the planar contact faces 232 FIG. 4) may be the same as the profile of lower cage half aperture 130 discussed above. In this embodiment, the profile consists of the planar contact surfaces 232 at angle A (FIG. 9) which blend into side radii as per the profile of the lower half. In the aperture of the upper half these radii are concentric with the radii of the outer retainers 234. However, these side radii meet the top radius at corners C′ (FIG. 4) without flat portions between the arcs.

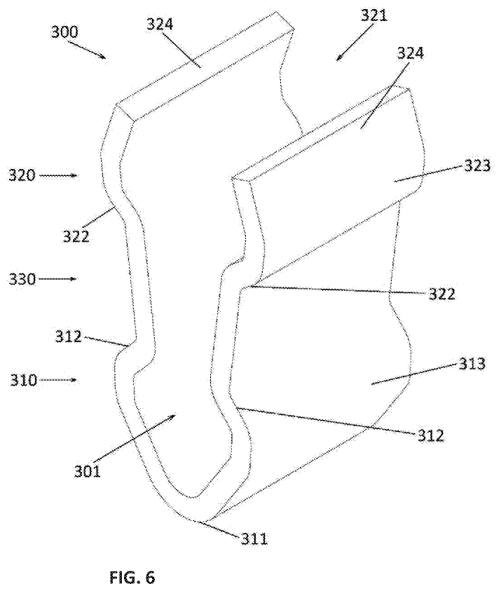

FIG. 6 shows a perspective view of a first embodiment of a spring fitting 300 for use with the cage halves 100, 200 described above. Spring fitting 300 is formed from a spring steel and may be press-formed or bent into the required shape. The spring fitting is hollow, having a generally U-shaped section with an aperture 301 through the centre when viewed from the radial direction. Spring fitting 300 has three sections, a first end section 310, a second end section 320 and a centre section 330 between the two end sections. The first end section 310 includes the closed end 311 of the spring fitting and the spring is therefore continuous at this end. The second end section 320 includes the open end 321 of the spring fitting and the spring is therefore discontinuous at this end. The two halves of the spring fitting at the second end section 320 can be urged together, against the spring force provided by the spring fitting. The first and second end sections 310, 320 are wider in the axial direction than the centre section 330.

When the spring fitting 300 is inserted into the cage halves 100, 200 in use with the cage half mating surfaces 110, 210 in contact, the first end section 310 is located in the lower cage half main aperture 130 and the second end section 320 is located in the upper cage half main aperture 230. The centre section 330 extends between the neck regions 140, 240 and across the mating surfaces 110, 210. The spring fitting is therefore configured to secure the two cage halves together. In addition, the spring fitting is configured to provide an engagement force on each cage half in the circumferential/tangential direction towards the mating surfaces to hold the cage halves together. This is discussed further below.

The first end section 310 has two angled contact faces 312 which extend from the wider part 313 of the first end section 310 to the narrower centre section 330. Similarly, the second end section 320 has two angled contact faces 322 which extend from the wider part 323 of the second end section 320 to the narrower centre section 330. The contact faces 312 and 322 provide a transition between the wider parts 313, 323 and the narrower centre section 330. When the spring fitting is inserted into the cage halves 100, 200 in use, the contact faces 312 and 322 are configured to engage with the contact faces 132 and 232 of the cage half main apertures respectively.

The ends 324 of the spring fitting second end section 320 are angled towards each other so that the spring fitting reduces in width from the wider part 323 to the end. This facilitates insertion of the spring fitting into the upper cage half in a circumferential/tangential direction as discussed below. During insertion, the ends engage with the guide surfaces 242 of the upper cage half 200 so that the spring is compressed as the second end section 320 is inserted into the main aperture 230.

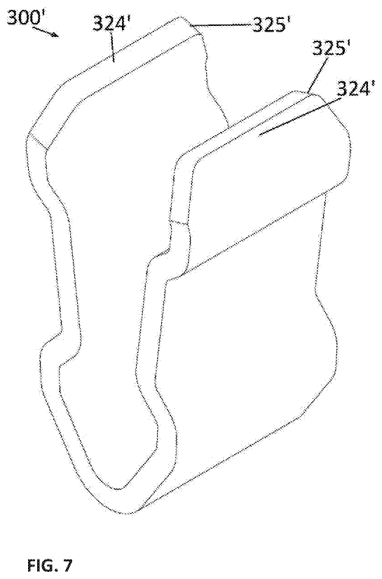

FIG. 7 shows a perspective view of a second embodiment of a spring fitting 300′. The only difference compared to the first embodiment is that the corners 325′ of the ends 324′ have been angled and rounded to further facilitate insertion of the spring fitting into the upper cage half. This feature may also assist with engagement of or prevent interference between the spring fitting and the inner backstop 233 and/or outer retainers 234.

With reference to FIGS. 8 and 9, the method of insertion of the spring fitting and the engagement of the two cage halves will now be described. Both figures show a detail side elevation view (looking along a radius of the bearing) of the outside of the split roller bearing cage.

In FIG. 8, the spring fitting 300 is located in the lower cage half 100 only, and the two cage halves are separated.

The spring fitting is inserted into the lower cage half in a radially-inward direction. The first end section 310 is inserted into main aperture 130. Backstop 133 serves to locate the spring fitting and prevents the fitting from passing completely through the main aperture. In this operation, the two halves of the spring fitting are compressed sufficiently so that the centre section 330 is able to clear the projections 141 of the neck region 140 during insertion. When the external compression force is released once the spring fitting is in position, the two halves of the centre section 330 contact the projections 141 of the neck region 140 and the arrangement is configured such that the spring fitting is held in compression and sufficiently closed so that the upper, second end section 320 will contact the guide surfaces 242 of the upper cage half and will automatically insert into the upper cage half in a circumferential/tangential direction as the cage halves are brought together. In addition, by being held in a level of compression, the spring fitting is less likely to fall out during subsequent handling and engagement of the two cage halves.

In the FIG. 8 configuration, the lower closed end 311 of the spring fitting is in contact with the lower surface 131 of the main aperture 130, so that the spring fitting resists the downward engagement force as the two cage halves are brought together and the spring fitting engages with the upper cage half 200.

As the two cage halves are brought together, the ends 324 of the spring fitting second end section 320, and subsequently the rest of the second end section 320, engage the guide surfaces 242 of the upper cage half 200 and the spring fitting is gradually compressed so that the second end section 320 passes in a circumferential/tangential direction through the neck region 240 and into the main aperture 230, where the spring fitting automatically expands again. This final, engaged configuration is shown in FIG. 9. The outer retainers 234 assist the insertion process by guiding the spring fitting into the main aperture 230, and also serve to prevent movement of the spring fitting in a radially-outward direction.

In the engaged configuration shown in FIG. 9, the spring fitting is held in compression by the engagement of the respective pairs of contact faces, faces 312 with 132 and faces 322 with 232. The halves of the spring fitting centre section 330 are generally parallel, but it is important to note that there is no longer any contact between the centre section and the projections 141, 241 of the neck regions 140 and 240. The contacts between the contact faces are the only points of contact between the spring fitting and cage halves which hold the spring fitting in compression. There may continue to be a point contact between the spring fitting and the lower cage half at the closed end 311, but this does not contribute to the compression of the spring fitting so is not significant functionally. There may be no contact at this point at all.

Due to the configuration of the contact faces, the axial force provided by the spring due to being held in compression has a component in the tangential direction towards the mating surfaces which provides a positive engagement force on the two cage halves, urging them together and resisting forces in use which may try to pull the cage halves apart.

The angle A between the planar contact faces 132/232 and the planar mating surfaces 110/210 is shown in FIG. 9 (and also in FIG. 5). As discussed above, the angle may be between 20 degrees and 70 degrees. In this example, the angle is about 45 degrees. The requirement is to provide a sufficient component of the axial spring force in the circumferential/tangential direction to meet the requirements of the application.

In the preferred embodiments described above, one spring fitting per side is shown. However, more than one spring fitting per side may be employed, such as two or more, depending on the operational requirements, such as the size of the bearing, operating speeds, or the level of interface force required. The fittings could be spaced axially or, if the cage has sufficient radial depth, more than one spring fitting could be used in a radial direction, i.e. in the same recesses.

The preferred embodiments show the insertion of the spring fitting in a radially-inwards direction, but the arrangement could be modified for insertion in a radially-outwards direction, e.g. by switching the locations of the retainers and backstops.

In the preferred embodiments described above, dowels 150 are provided on the lower cage half 100 which project from the mating surface 110 and engage with corresponding recesses in the upper cage half mating surface 220. It will be understood that dowels could be provided on either or both cage halves. Dowels provide correct alignment of the two cage halves. Other features may of course be provided instead of dowels to align the two cage halves, such as angled surfaces, multi-faceted surfaces, steps or notches. The main function of the spring fitting is to urge the two halves together rather than to align them, although the spring fitting may also provide a sufficient alignment function such that dowels or other alignment features are not required.

It is desirable that the features of the cage can be economically produced as part of a machining cycle, as this is the method used to manufacture the cages. All the features of the cage, including those related to the invention, are designed to be formed by a series of prismatic cutters (drills and milling cutters). The cage halves can be machined from a solid ring of material using standard or slightly modified cutting tools and simple machining techniques.

At least in preferred embodiments, the various features of the invention are designed such that once the spring fitting is fully engaged into both cage halves, there is a significant interface force between the two halves of the cage, which is sustained by tension in the two “legs” of the spring fitting. This means that the dynamic forces experienced by the cage and transmitted from one half of the cage to the other are mainly transmitted by variation in the interface force between the cage halves rather than by variation in the tension in the spring fitting. This is similar to the transmission of load through a bolted joint, in which the bolt tension hardly varies. Once the spring fitting is assembled into the bottom half of the cage, the top half of the cage can be assembled to the bottom half simply by pushing the two halves of the cage together, the elasticity of the spring fitting allowing the two legs of the open end to be forced towards each other through the “mouth” of the aperture in the top half of the cage. Once forced past the “mouth” the fitting springs outwards to engage the angled faces. However, there is insufficient elasticity for the closed end of the spring fitting to be inserted into the bottom half of the cage in the same way. Instead, it is arranged to be fitted into the bottom half of the cage by inserting it in a direction perpendicular to the direction in which the fitting is required to apply load. The aperture for the spring fitting is open to the outside diameter of the cage, allowing the two legs of the spring fitting to be sprung together (e.g. with a pair of pliers) and slid into position in the cage half in a radial direction.

At least in preferred embodiments, the invention provides a method of joining the two halves of a cage which can be employed in smaller sizes of bearing and which does not interfere with the roller pockets. The circumferential extent of the connection features is less than the prior art methods (e.g. bolt/screw), taking into account the need for a screw aperture and access above/below for a tightening tool. In addition, at least in preferred embodiments, the invention provides an interface force between the two halves of the cage which can withstand the dynamic forces experienced by the cage in use.

A further advantage provided by the invention, at least in preferred embodiments, is that the bearing can be supplied without loose parts for assembly on site. Although the spring fitting is completely separable from the cage, it can be fitted into the bottom half of the cage at the factory. On site, the bearing cage can be assembled around the shaft simply by pushing the two halves together until the spring fittings engage. This avoids the need to supply the bearing cage with additional loose parts, such as separate U-clips, small screws etc. which are at risk of being mislaid on site.

1. A cage for a split rolling element bearing comprising:
a first cage portion;
a second cage portion, separable from the first cage portion; and
a spring fitting configured to releasably connect the first and second cage portions together to form the cage in use,
wherein each cage portion has a mating surface which is configured to contact the other cage portion when the first and second cage portions are engaged in use and a recess extending circumferentially from the mating surface, wherein each recess has a main aperture and a neck region located circumferentially between the main aperture and the mating surface, wherein the main aperture is wider in an axial direction than the neck region,
wherein the spring fitting comprises first and second end sections joined by a centre section, wherein the first and second end sections are wider in the axial direction than the centre section such that, when the mating surfaces of each cage portion are in contact, each spring fitting end section is configured to be located in a respective main aperture and the centre section extends across the neck regions, and the spring fitting is configured to provide an engagement force in a circumferential direction which retains the first and second cage portions in an engaged position.

2. The cage of claim 1, wherein the spring fitting is formed from a spring material.

3. The cage of claim 1, wherein the spring fitting is hollow.

4. The cage of claim 3, wherein the first end section of the spring fitting is continuous and the second end section of the spring fitting is discontinuous, such that the two halves of the spring fitting at the second end section can be urged together, against a spring force provided by the spring fitting.

5. The cage of claim 4, wherein the spring fitting has a generally U-shaped section.

6. The cage of claim 4, wherein the ends of the spring fitting at the second end section are angled towards each other.

7. The cage of claim 1, wherein the spring fitting first end section is configured to be inserted into the main aperture of the first cage portion in a radial direction and the spring fitting second end section is configured to be inserted into the main aperture of the second cage portion in a circumferential/tangential direction.

8. The cage of claim 1, wherein the second cage portion recess is provided with one or more guide surfaces between the mating surface and the neck region to guide the spring fitting into the main aperture during insertion.

9. The cage of claim 8, wherein the one or more guide surfaces is an arc of a cylinder.

10. The cage of claim 1, wherein the cage portion neck region is formed by a projection on one or both sides of the recess.

11. The cage of claim 10, wherein a main aperture contact face is formed adjacent the projection, forming part of the edge of the main aperture of the recess and wherein a corresponding contact face is provided on the spring fitting.

12. The cage of claim 11, wherein the main aperture and corresponding contact faces are configured to engage when the spring fitting is inserted into the recess.

13. The cage of claim 12, wherein, when the spring fitting is inserted into both recesses, the spring is held in compression in the axial direction which, through the engagement of the main aperture and corresponding contact faces, provides the engagement force in the circumferential direction which urges the first and second cage portions together.

14. The cage of claim 11, wherein the main aperture contact face is substantially planar and is at an angle of between 20 degrees and 70 degrees to the mating surface or a plane through an axis of the split rolling element bearing.

15. The cage of claim 14, wherein the spring fitting contact face is substantially planar and is substantially parallel to the corresponding main aperture contact face with which the spring fitting contact face engages in use.

16. The cage of claim 1, wherein the main aperture is provided with a projection or flange configured to prevent movement of the spring fitting in a radially-outward direction when the spring fitting is engaged with the first and/or second cage portion.

17. The cage of claim 16, wherein the projection or flange is located at a radially-outer end of the main aperture.

18. The cage of claim 16, wherein the projection or flange is provided on the second cage portion only.

19. The cage of claim 1, wherein the main aperture is provided with a projection or flange to prevent movement of the spring fitting in a radially-inward direction when the spring fitting is engaged with the first and/or second cage portion.

20. The cage of claim 19, wherein the projection or flange is located at a radially-inner end of the main aperture.

21. The cage of claim 19, wherein the projection or flange is provided on the first cage portion only or is provided on the first and second cage portions.

22. A split rolling element bearing including the cage of claim 1.

23. The split rolling element bearing of claim 22, wherein the split rolling element bearing is selected from: a split roller bearing, a split spherical roller bearing, a split cylindrical roller bearing, and a split taper roller bearing.
